(19) United States
(12) Patent Application Publication
(10) Pub. No.: US 2024/0088384 A1
(43) Pub. Date: Mar. 14, 2024

(54) NEGATIVE ELECTRODE MIXTURE COMPOSITE FOR FLUORIDE ION SECONDARY BATTERY, NEGATIVE ELECTRODE AND SECONDARY BATTERY FOR FLUORIDE ION SECONDARY BATTERY USING SAID COMPOSITE, AND METHOD FOR PRODUCING SAID COMPOSITE

(71) Applicant: HONDA MOTOR CO., LTD., Tokyo (JP)

(72) Inventors: Akihisa TANAKA, Saitama (JP); Yoshiyuki MORITA, Saitama (JP)

(21) Appl. No.: 17/767,450

(22) PCT Filed: Oct. 9, 2019
(86) PCT No.: PCT/JP2019/039886

§ 371 Date: Apr. 8, 2022

(51) Int. Cl. H01M 4/58; C01F 7/50; H01M 4/136; H01M 10/05

(52) U.S. Cl. CPC H01M 4/582; C01F 7/50; H01M 4/136; H01M 10/05; H01M 2004/021

(57) ABSTRACT

Provided are: a negative electrode mixture composite which is for a fluoride ion secondary battery having high initial charge/discharge efficiency, and by which the fluoride ion secondary battery that starts charging can be achieved; a negative electrode and a secondary battery for a fluoride ion secondary battery using said composite; and a method for producing said composite. This composite is formed with other components of a negative electrode mixture, using, as negative electrode active materials, nanoparticle-sized aluminum and modified aluminum fluoride having vacancies due to the desorption of fluoride ions, and thus forming a coating due to aluminum fluoride formed by a refluorination reaction after defluorination is suppressed, and the aggregation of particles of negative electrode active materials is suppressed.

### TECHNICAL FIELD

The present invention relates to a negative electrode material mixture composite for a fluoride ion secondary battery, a negative electrode for a fluoride ion secondary battery and a secondary battery each using the composite and a method for manufacturing the composite.

### BACKGROUND ART

Conventionally, as secondary batteries having a high energy density, lithium ion secondary batteries are widely used. The lithium ion secondary battery has a structure in which a separator is present between a positive electrode and a negative electrode and a liquid electrolyte (electrolytic liquid) is filled.

Since the electrolytic liquid of the lithium ion secondary battery is generally a flammable organic solvent, in particular, there may be a problem in safety for heat. Hence, instead of an organic liquid electrolyte, a solid-state battery using an inorganic solid electrolyte is proposed (see Patent Document 1).

As the battery using the solid electrolyte as described above, a secondary battery using fluoride ions is also considered (see Patent Document 2). A fluoride ion secondary battery is a secondary battery which uses a fluoride ion (F⁻) as a carrier, and it is known that the fluoride ion secondary battery has high theoretical energy. It is expected that the battery characteristics thereof exceed those of the lithium ion secondary battery.

Here, as a negative electrode active material for the fluoride ion secondary battery, for example, MgF₂, CaF₂, CeF₃ and the like are reported (see Non-Patent Documents 1 and 2). However, in the fluoride ion secondary batteries using these negative electrode active materials, the charge/discharge efficiency thereof is 10 to 20%, and thus the energy efficiency thereof serving as a secondary battery is disadvantageously low. The charge/discharge capacity thereof is only about 10 to 20% of a theoretical capacity, and thus a high capacity was not achieved as compared with the lithium ion secondary battery and an Ni-MH battery which are currently used.

As the solid electrolyte used in the fluoride ion secondary battery, for example, La₁₋ₓBaₓF₃₋ₓ where x=0.01 to 0.2 (hereinafter referred to as an LBF) is mentioned (see Non-Patent Documents 1 to 4). As shown in FIG. 1, the reduction side potential window of the LBF receives a constraint at −2.41 V vs. Pb/PbF₂ which is the potential of La/LaF₃ calculated from Gibbs energy.

By contrast, as the potentials of the negative electrode active materials for the fluoride ion secondary battery which are currently reported, as shown in FIG. 1, MgF₂ has a potential of −2.35 to −2.87 V vs. Pb/PbF₂, CaF₂ has a potential of −2.85 to −2.89 V vs. Pb/PbF₂ and CaF₂ has a potential of −2.18 to −2.37 V vs. Pb/PbF₂. Hence, under the constraint of −2.41 V serving as the reduction potential window of the LBF, the defluorination/refluorination reactions of the negative electrode active materials described above could not be provided with consideration given to the overvoltage thereof.

On the other hand, with respect to the positive electrode reaction, for example, for positive electrode active materials such as Cu/CuF₂ and Bi/BiF₃, the results of charge/discharge tests indicating high utilization rates and reversible reactions are reported (see Patent Documents 3 and 4 and Non-Patent Documents 1 to 3).

Hence, in order to achieve, in the fluoride ion secondary battery, a practical all-battery reaction in which positive/negative electrode reactions are combined, it was necessary to provide a negative electrode active material which causes a reversible negative electrode reaction at a high utilization rate.

For this requirement, Patent Document 5 focuses attention on aluminum fluoride (AlF₃: −1.78 V vs. Pb/PbF₂) in which charge/discharge reactions (defluorination/refluorination reactions) are present in the constraint of −2.41 V serving as the potential window of the LBF that is the fluoride ion solid electrolyte, and further proposes a negative electrode active material obtained by modifying the aluminum fluoride (AlF₃) such that fluoride ions (F⁻) are previously and partially desorbed from the structure of the perfect crystal of six-coordinated octahedron included in the aluminum fluoride (AlF₃) and that pores are provided in positions where fluorine atoms were present.

In the negative electrode active material of Patent Document 5, the pores which are provided in the positions where fluorine atoms were present serve as the starting point of the defluorination/refluorination reactions, and thus it is possible to cause a desired negative electrode reaction at a high utilization rate in a reversible manner.
Patent Document 1: Japanese Unexamined Patent Application, Publication No. 2000-106154
Patent Document 2: Japanese Unexamined Patent Application, Publication No. 2017-050113
Patent Document 3: Japanese Unexamined Patent Application, Publication No. 2018-206755
Patent Document 4: Japanese Unexamined Patent Application, Publication No. 2019-087403
Patent Document 5: Japanese Patent Application No. 2018-059703
Non-Patent Document 1: J. Mater. Chem. A. 2014.2.20861-20872
Non-Patent Document 2: J. Solid State Electrochem (2017) 21:1243-1251
Non-Patent Document 3: J. Mater. Chem., 2011, 21, 17059
Non-Patent Document 4: Dalton Trans., 2014, 43, 15771-15778

### DISCLOSURE OF THE INVENTION

### Problems to be Solved by the Invention

However, in the fluoride ion secondary battery using the negative electrode active material proposed in Patent Document 5, the electrification efficiency of an electrochemical first cycle is about 50%, and thus the electrification efficiency was required to be further enhanced.

Since in the fluoride ion secondary battery using the negative electrode active material proposed in Patent Document 5, a compound which includes fluoride ions is selected as a positive electrode serving as the opposite electrode, the fluoride ion secondary battery is a battery which starts from discharge. However, in terms of stability of an active material within an electrode, the manufacturing of a secondary battery is preferably performed in a discharged state where an energy state is low. In other words, the secondary battery is preferably a battery which starts from charge.

The present invention is made in view of the background technologies described above, and an object thereof is to provide, in a fluoride ion secondary battery, a negative electrode material mixture composite for a fluoride ion secondary battery which can realize the fluoride ion secondary battery having high initial charge/discharge efficiency and starting from charge, a negative electrode for a fluoride ion secondary battery and a secondary battery each using the composite and a method for manufacturing the composite.

### Means for Solving the Problems

The present inventors have conducted thorough studies on the cause of the reduction in the electrification efficiency of the negative electrode active material proposed in Patent Document 5. Then, the present inventors have considered that the aluminum fluoride formed by the refluorination reaction after the defluorination coats the surface of the negative electrode active material to form an insulating layer, and that thus the reactivity is lowered.

In addition, the present inventors have considered that since the negative electrode active material is nanoparticles, the particles are agglomerated at the time of initial charge/discharge, and that consequently, an electron conduction path and an ion conduction path are not sufficiently formed.

The present inventors further have considered that, when a compound capable of discharging fluoride ions serving as an ion carrier at the time of charge can be caused to be present as the negative electrode active material, it is possible to form a battery using, as a positive electrode, a compound which does not include fluoride ions.

Then, the present inventors have found that when nanoparticle-sized aluminum and modified aluminum fluoride including pores caused by desorption of fluoride ions are used as the negative electrode active material to form a composite together with the other components of a negative electrode material mixture, it is possible to suppress the coating with the aluminum fluoride formed by the refluorination reaction after the defluorination and to suppress the agglomeration of the particles of the negative electrode active material, and that consequently, a fluoride ion secondary battery having high initial charge/discharge efficiency and capable of starting from charge can be realized, with the result that the present invention is completed.

Specifically, a negative electrode material mixture composite for a fluoride ion secondary battery according to the present invention includes: a negative electrode active material; and a fluoride ion conductive fluoride, wherein the negative electrode active material includes aluminum and a modified aluminum fluoride material having pores caused by desorption of fluoride ions.

The pores may serve as a starting point of a defluorination reaction and a refluorination reaction.

The pores may be a region where fluorine atoms were present in the aluminum fluoride before being modified.

The aluminum may be in the form of particles with an average particle diameter of 10 nm to 200 nm.

The negative electrode material mixture composite for a fluoride ion secondary battery may further include carbon black.

A negative electrode for a fluoride ion secondary battery according to another aspect of the invention includes the negative electrode material mixture composite for a fluoride ion secondary battery.

A fluoride ion secondary battery according to another aspect of the invention includes: the negative electrode; a solid electrolyte; and a positive electrode.

A method for manufacturing a negative electrode material mixture composite for a fluoride ion secondary battery according to another invention includes: a mixture step of mixing a negative electrode active material, a fluoride ion conductive fluoride and carbon black to obtain a negative electrode material mixture; a complexing step of subjecting the negative electrode material mixture to grinding and mixing treatment to complex the negative electrode active material, the fluoride ion conductive fluoride and the carbon black so as to obtain a composite, and the negative electrode active material includes aluminum and a modified aluminum fluoride material having pores caused by desorption of fluoride ions.

In the method for manufacturing a negative electrode material mixture composite for a fluoride ion secondary battery, the pores may serve as a starting point of a defluorination reaction and a refluorination reaction.

In the method for manufacturing a negative electrode material mixture composite for a fluoride ion secondary battery, the pores may be a region where fluorine atoms were present in the aluminum fluoride before being modified.

In the method for manufacturing a negative electrode material mixture composite for a fluoride ion secondary battery, the aluminum may be in the form of particles with an average particle diameter of 10 nm to 200 nm.

In the method for manufacturing a negative electrode material mixture composite for a fluoride ion secondary battery, the grinding and mixing treatment may be dry grinding.

In the method for manufacturing a negative electrode material mixture composite for a fluoride ion secondary battery, the grinding and mixing treatment may be performed with a ball mill.

### Effects of the Invention

With a negative electrode material mixture composite for a fluoride ion secondary battery according to the present invention, it is possible to realize a fluoride ion secondary battery which has high initial charge/discharge efficiency and which starts from charge.

### BRIEF DESCRIPTION OF THE DRAWINGS

FIG. 1 is a diagram showing potentials calculated from Gibbs energy;

FIG. 2 is a diagram showing a method for producing fluoride ion secondary batteries in Example and Comparative Examples;

FIG. 3 is a cross-sectional view of the fluoride ion secondary batteries produced in Example and Comparative Examples;

FIG. 4 is charge/discharge curves of the fluoride ion secondary batteries produced in Example and Comparative Examples;

FIG. 5 is a graph showing charge/discharge behaviors in the first and second cycles of the fluoride ion secondary battery produced in Example 1; and

FIG. 6 is a graph showing the transition of the capacity up to the fifth cycle in the fluoride ion secondary battery produced in Example 1.

### PREFERRED MODE FOR CARRYING OUT THE INVENTION

An embodiment of the present invention will be described below.

### <Negative Electrode Material Mixture Composite for Fluoride Ion Secondary Battery>

The negative electrode of a fluoride ion secondary battery needs to be able to store fluoride ions (F⁻) at the time of discharge and to discharge fluoride ions (F⁻) at the time of charge.

A negative electrode material mixture composite for a fluoride ion secondary battery according to the present invention includes a negative electrode active material and a fluoride ion conductive fluoride, and is a composite which includes, as the negative electrode active material, aluminum and modified aluminum fluoride material having pores caused by desorption of fluoride ions.

The negative electrode material mixture composite for a fluoride ion secondary battery according to the present invention preferably includes, as constituent components, aluminum and the modified aluminum fluoride material serving as the negative electrode active material and the fluoride ion conductive fluoride, and may be a composite which arbitrarily includes other components.

In the negative electrode material mixture composite for a fluoride ion secondary battery according to the present invention, aluminum serving as the negative electrode active material forms an alloy with another constituent component of the composite, and aluminum is not present as a simple substance.

### [Shape of Composite]

The shape of the negative electrode material mixture composite for a fluoride ion secondary battery according to the present invention is not particularly limited. Among various shapes, the negative electrode material mixture composite is preferably granulated into spherical particles. Within each of the particles, aluminum and the modified aluminum fluoride material serving as the negative electrode active material, the fluoride ion conductive fluoride and other arbitrary components are preferably present.

In a case where the negative electrode material mixture composite is granulated into spherical particles, when the electrode is pressed, the electrode into which the negative electrode material mixture composite is further filled without any gap can be produced, with the result that the volumetric energy density of the battery can be enhanced.

When the negative electrode material mixture composite is spherical, the constituent components of the composite are present within each of the composite particles, and thus an electron conduction path and an ion conduction path for fluorination/defluorination reactions necessary for an electrochemical reaction can be formed into nanosized paths.

In order to enhance the efficiency of the electrochemical reaction in the fluoride ion secondary battery, it is effective to enlarge the surface area of the materials of the negative electrode, and when the negative electrode material mixture composite is spherical, a negative electrode for a fluoride ion secondary battery which is the aggregate of spheres has a high surface area. Consequently, a contact area with a solid electrolyte included in an adjacent solid electrolyte layer can be increased.

### (Average Particle Diameter)

When the negative electrode material mixture composite for a fluoride ion secondary battery according to the present invention is in the form of spherical particles, the average particle diameter thereof is preferably in a range of 0.5 to 10 μm. The average particle diameter is particularly preferably in a range of 1 to 5 μm.

The average particle diameter of the negative electrode material mixture composite for a fluoride ion secondary battery is in the range described above, and thus when grinding and mixing treatment for obtaining the composite particles is performed, the particles are made to collide with each other so as to be granulated, with the result that within the microsized particles, the electron conduction path and the ion conduction path for fluorination/defluorination reactions are securely adhered and formed. Since the structure of the particles having the electron conduction path and the ion conduction path can follow a change in volume caused by the reaction of aluminum serving as the negative electrode active material, the collapse of the structure of a negative electrode layer can be suppressed, with the result that the reversibility of the electrochemical reaction can be more improved.

### [Negative Electrode Active Material]

The negative electrode active material of the negative electrode material mixture composite for a fluoride ion secondary battery according to the present invention includes aluminum and the modified aluminum fluoride material having pores caused by desorption of fluoride ions.

### [Aluminum]

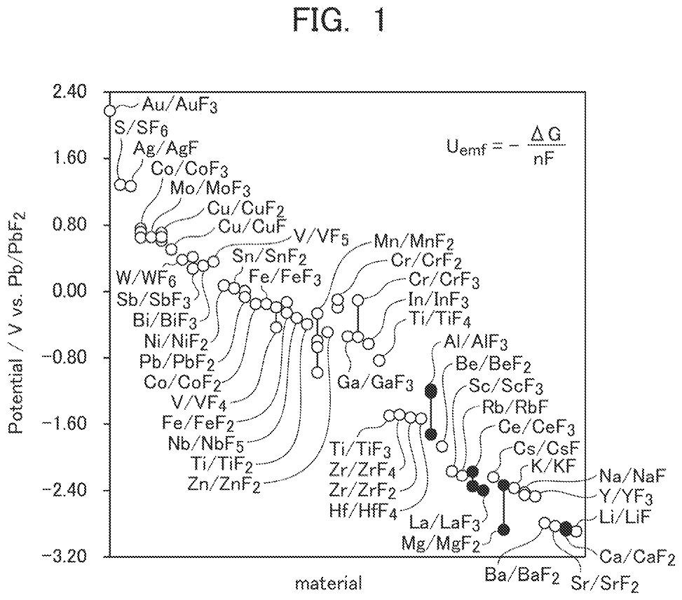

As shown in FIG. 1, the potential of aluminum fluoride AlF₃ which is a fluoride of aluminum is −1.78 V vs. Pb/PbF₂, and charge/discharge reactions (defluorination/refluorination reactions) are present in the constraint of −2.41 V serving as the potential window of an LBF which is a fluoride ion solid electrolyte.

Hence, the defluorination/refluorination reactions of aluminum sufficiently proceed under the constraint of −2.41 V serving as the reduction potential window of the LBF with consideration given to the overvoltage thereof. Since aluminum is an inexpensive material, it is economically advantageous to use aluminum.

On the surface of aluminum, an oxide film may be present.

### (Shape)

The shape of aluminum serving as the negative electrode active material is preferably spherical. The negative electrode active material is spherical, and thus when the electrode is pressed, the electrode into which the negative electrode active material is further filled without any gap can be produced, with the result that the volumetric energy density of the battery can be enhanced.

### (Average Particle Diameter)

The aluminum is preferably in the form of particles with an average particle diameter in a range of 10 to 200 nm, particularly preferably in a range of 40 to 100 nm.

When the average particle diameter of the aluminum particles serving as the negative electrode active material is in the range of 10 to 200 nm, the resulting negative electrode material mixture composite for a fluoride ion secondary battery can be a substantially true spherical granulated composite.

### [Modified Aluminum Fluoride Material Having Pores Caused by Desorption of Fluoride Ions]

In the present invention, the modified aluminum fluoride material serving as the second component of the negative electrode active material includes pores caused by desorption of fluoride ions.

### (Pores)

As described above, the pores in the modified aluminum fluoride material are formed by desorption of fluoride ions, and serve as the starting point of the defluorination/refluorination reactions. Specifically, the pores are present, and thus the aluminum fluoride (AlF₃) that is an insulator whose conductivity is substantially zero ionically and electronically is modified, with the result that it is possible to cause a negative electrode reaction to proceed at a high utilization rate in a highly reversible manner.

The pores are formed in a region where fluorine atoms were present in the aluminum fluoride (AlF₃) before being modified. The aluminum fluoride (AlF₃) before being modified has a structure of a six-coordinated octahedron in which an Al atom is arranged in the center and six fluorine atoms are arranged at the vertex. In the modified aluminum fluoride material used in the present invention, among the six fluorine atoms present at the vertex, part of the fluorine atoms are removed, and positions where the fluorine atoms which were removed and desorbed were present serve as pores.

In the modified aluminum fluoride material used in the present invention, not all of the six fluorine atoms in the aluminum fluoride (AlF₃) are desorbed, only part of the fluorine atoms are removed and thus pores are provided.

### (Method for Manufacturing Modified Aluminum Fluoride Material)

In a method for manufacturing the modified aluminum fluoride material used in the present invention, the aluminum fluoride and an alkali metal or an alkali earth metal are brought into contact to desorb fluoride ions from the aluminum fluoride, and thus the positions where the fluorine atoms desorbed as the fluoride ions were present serve as pores.

The alkali metal or the alkali earth metal whose potential is lower than the potential of the defluorination/refluorination reactions of the aluminum fluoride (AlF₃) is brought into contact to form a fluoride, and thus a reaction occurs in which part of the fluorine atoms are removed from the aluminum fluoride (AlF₃).

In the modified aluminum fluoride material used in the present invention, not all of the six fluorine atoms in the aluminum fluoride (AlF₃) are desorbed. In other words, only part of the fluorine atoms are removed, and thus a reaction in which the aluminum fluoride (AlF₃) is changed into aluminum metal is prevented from occurring.

The aluminum fluoride (AlF₃) absorbs water in the atmosphere to form 0.5 hydrate or 3 hydrate which is more stable. Hence, when the aluminum fluoride is modified, the aluminum fluoride (AlF₃) which has been subjected to dehydration treatment is preferably used. As a method for performing the dehydration treatment, for example, a method for performing vacuum burning at a temperature of about 250 to 300° C. or the like is mentioned.

The alkali metal or the alkali earth metal which is brought into contact with the aluminum fluoride before being modified is not particularly limited. Examples of the alkali metal can include lithium (Li), sodium (Na), potassium (K), rubidium (Rb), cesium (Cs) and the like, and examples of the alkali earth metal can include magnesium (Mg), calcium (Ca), strontium (Sr), barium (Ba) and the like.

Among them, lithium (Li) metal is preferably used. Since the lithium (Li) metal is the lightest of all metal elements, the capacity (mAh/g) per weight of the active material can be enhanced.

As a commercially available lithium (Li) metal, for example, Li foil made by Honjo Metal Co., Ltd. (purity of 99.8%) and the like are mentioned. Although the shape of the lithium (Li) metal is not particularly limited, since it is easy to mix it with the aluminum fluoride (AlF₃), the shape of a chip or the shape of beads is preferable.

An example of the reaction which occurs when the aluminum fluoride (AlF₃) and the alkali metal or the alkali earth metal are brought into contact is shown below. The following is the reaction of the lithium (Li) metal which is an alkali metal and the aluminum fluoride (AlF₃).

xLi+(1-x)AlF₃

->xLiF+(1-x)AlF_{3-4x/(1-x)} (1)

->xLiF+(1-4x/3)AlF₃+(x/3)Al (2)

->(x/3)Li₃AlF₆+(1-5z/3)AlF₃+(x/3)Al (3)

In the manufacturing of the modified aluminum fluoride material used in the present invention, the reaction is prevented from proceeding to the stages of formula (2) and formula (3) where the aluminum fluoride (AlF₃) is changed into aluminum metal, and the reaction is stopped at the stage of formula (1) where only part of the fluorine atoms are removed.

A method for bringing the aluminum fluoride (AlF₃) and the alkali metal or the alkali earth metal into contact is not particularly limited as long as the method is used in which the reaction is prevented from proceeding such that the aluminum fluoride (AlF₃) is changed into aluminum metal.

For example, a method is mentioned in which the necessary amount of aluminum fluoride (AlF₃) and the necessary amount of alkali metal or alkali earth metal are weighed, preliminary mixing is performed as necessary and mixing is performed with a ball mill or the like.

Since the aluminum fluoride (AlF₃) and the alkali metal or the alkali earth metal are highly reactive with water, they are preferably brought into contact in an environment where it is possible to prevent contact with water in the atmosphere by use of a glove box or the like.

The ratio of the alkali metal or the alkali earth metal which is used to the total of the alkali metal or the alkali earth metal and the aluminum fluoride is preferably 5 to 20 mol %. The ratio is 5 to 20 mol %, and thus a large charge/discharge capacity is obtained, and simultaneously, a reaction overvoltage is reduced, with the result that it is possible to form a fluoride ion secondary battery in which the charge/discharge efficiency is increased.

The ratio of the alkali metal or the alkali earth metal to the total of the alkali metal or the alkali earth metal and the aluminum fluoride is further preferably 5 to 15 mol %, and is most preferably 10 to 15 mol %.

### [Fluoride Ion Conductive Fluoride]

The fluoride ion conductive fluoride which is an essential constituent component of the negative electrode material mixture composite for a fluoride ion secondary battery according to the present invention is not particularly limited as long as the fluoride ion conductive fluoride is a fluoride having fluoride ion conductivity. For example, Ce_{0.95}Ba_{0.05}F_{2.95}, Ba_{0.6}La_{0.4}F_{2.4} and the like are mentioned.

Among them, Ce_{0.95}Ba_{0.05}F_{2.95} is preferably used because it has high ion conductivity.

### (Average Particle Diameter)

The fluoride ion conductive fluoride is preferably in the form of particles with an average particle diameter in a range of 0.1 to 100 μm, particularly preferably in a range of 0.1 to 10 μm.

When the average particle diameter of the fluoride ion conductive fluoride particles is in the range of 0.1 to 100 μm, it is possible to form an electrode of a thin film having relatively high ion conductivity.

### [Other Components]

The negative electrode material mixture composite for a fluoride ion secondary battery according to the present invention may arbitrarily include other components other than aluminum and the modified aluminum fluoride material serving as the negative electrode active material and the fluoride ion conductive fluoride which are essential constituent components. Examples of the other components include a conductive aid, a binder and the like.

### (Conductive Aid)

In particular, the negative electrode material mixture composite for a fluoride ion secondary battery according to the present invention preferably includes carbon black as the conductive aid. The carbon black is present within the composite, and thus the electron conduction path and the ion conduction path for fluorination/defluorination reactions necessary for the electrochemical reaction can be easily formed.

The type of carbon black is not particularly limited, and examples thereof include furnace black, Ketjen black, acetylene black and the like.

Although the average particle diameter of the carbon black is not particularly limited, the average particle diameter is preferably in a range of 20 to 50 nm.

The average particle diameter of the carbon black is in the range of 20 to 50 nm, and thus an electrode having high electron conductivity with a small weight can be formed.

[Composition]

### (Aluminum)

The ratio of aluminum to the entire negative electrode material mixture composite for a fluoride ion secondary battery according to the present invention is preferably 1 to 25% by mass, and is further preferably in a range of 5 to 13% by mass.

In the negative electrode material mixture composite for a fluoride ion secondary battery according to the present invention, the ratio of aluminum is in the range described above, and thus the capacity of the obtained fluoride ion secondary battery per weight is increased.

### (Modified Aluminum Fluoride Material)

The ratio of the modified aluminum fluoride material to the entire negative electrode material mixture composite for a fluoride ion secondary battery according to the present invention is preferably 5 to 25% z by mass, and is further preferably in a range of 5 to 20% by mass.

In the negative electrode material mixture composite for a fluoride ion secondary battery according to the present invention, the ratio of the modified aluminum fluoride material is in the range described above, and thus the capacity of the obtained fluoride ion secondary battery per weight is increased.

### (Ratio Between Aluminum and Modified Aluminum Fluoride Material)

In the negative electrode material mixture composite for a fluoride ion secondary battery according to the present invention, a mass ratio between aluminum and the modified aluminum fluoride material serving as the negative electrode active material is preferably in a range of 1:9 to 9:1. The mass ratio is further preferably in a range of 2:8 to 8:2, and is most preferably in a range of 2:8 to 5:5.

In the negative electrode material mixture composite for a fluoride ion secondary battery according to the present invention, the mass ratio between aluminum and the modified aluminum fluoride material is in the range described above, and thus the capacity per weight is increased.

### (Fluoride Ion Conductive Fluoride)

The ratio of the fluoride ion conductive fluoride to the entire negative electrode material mixture composite for a fluoride ion secondary battery according to the present invention is preferably 70 to 90% by mass, and is further preferably in a range of 80 to 90% by mass.

In the negative electrode material mixture composite for a fluoride ion secondary battery according to the present invention, the ratio of the fluoride ion conductive fluoride is in the range described above, and thus an electrode having high ion conductivity can be formed.

### (Conductive Aid)

When the negative electrode material mixture composite for a fluoride ion secondary battery according to the present invention includes the conductive aid, the ratio of the conductive aid to the entire negative electrode material mixture composite for a fluoride ion secondary battery is preferably 5 to 25% by mass, and is further preferably in a range of 5 to 10% by mass.

In the negative electrode material mixture composite for a fluoride ion secondary battery according to the present invention, the ratio of the conductive aid is in the range described above, and thus an electrode having high electron conductivity can be formed.

### (Ratio Between Aluminum, Modified Aluminum Fluoride Material,

Fluoride Ion Conductive Fluoride and Conductive Aid) In the negative electrode material mixture composite for a fluoride ion secondary battery according to the present invention, a mass ratio between aluminum, the modified aluminum fluoride material, the fluoride ion conductive fluoride and the conductive aid is preferably in a range of 1 to 25:5 to 25:70 to 90:5 to 25. The mass ratio is further preferably in a range of 5 to 13:5 to 20:80 to 90:5 to 10.

In the negative electrode material mixture composite for a fluoride ion secondary battery according to the present invention, the mass ratio between aluminum, the modified aluminum fluoride material, the fluoride ion conductive fluoride and the conductive aid is in the range described above, and thus the capacity per mass is increased.

### <Negative Electrode for Fluoride Ion Secondary Battery>

A negative electrode for a fluoride ion secondary battery according to the present invention includes the negative electrode material mixture composite for a fluoride ion secondary battery according to the present invention. As long as the negative electrode includes the negative electrode material mixture composite for a fluoride ion secondary battery according to the present invention, the other configurations are not particularly limited.

### <Fluoride Ion Secondary Battery>

A fluoride ion secondary battery according to the present invention includes: the negative electrode for a fluoride ion secondary battery which includes the negative electrode material mixture composite for a fluoride ion secondary battery according to the present invention; a solid electrolyte; and a positive electrode. As long as the fluoride ion secondary battery according to the present invention uses the negative electrode including the negative electrode material mixture composite for a fluoride ion secondary battery according to the present invention, the other configurations are not particularly limited.

In the present invention, a positive electrode material is selected which provides a sufficiently high standard electrode potential to the standard electrode potential of the negative electrode for a fluoride ion secondary battery including the negative electrode material mixture composite for a fluoride ion secondary battery according to the present invention, and thus it is possible to realize the enhanced characteristics of the fluoride ion secondary battery and a desired battery voltage.

In particular, as the positive electrode, a material which does not include fluoride ions is selected, and thus a battery which starts from charge can be realized. In other words, it is possible to manufacture the battery in a discharged state where an energy state is low, and thus the stability of the active material within the electrode can be enhanced.

Examples of the positive electrode which is preferable for the fluoride ion secondary battery according to the present invention include Cu, Bi, Ag and the like, and among them, Cu is particularly preferable because it is an inexpensive material.

### <Method for Manufacturing Negative Electrode Material Mixture Composite for Fluoride Ion Secondary Battery>

A method for manufacturing the negative electrode material mixture composite for a fluoride ion secondary battery according to the present invention includes a mixture step and a complexing step.

### [Mixture Step]

The mixture step in the method for manufacturing the negative electrode material mixture composite for a fluoride ion secondary battery according to the present invention is a step of mixing the negative electrode active material, the fluoride ion conductive fluoride and the carbon black to obtain a negative electrode material mixture, and in the present invention, the negative electrode active material includes aluminum and the modified aluminum fluoride material having pores caused by desorption of fluoride ions.

Aluminum and the modified aluminum fluoride material serving as the negative electrode active material, the fluoride ion conductive fluoride and the carbon black serving as the conductive aid are the same as those described above. Aluminum, the modified aluminum fluoride material, the fluoride ion conductive fluoride and the carbon black are preferably included as essential components, and other materials may be arbitrarily mixed.

A method for the mixing is not particularly limited, and it is preferable to weigh the desired masses of the individual components and to put them into the same space simultaneously or sequentially so as to mix them. When they are sequentially put, the order thereof is not particularly limited.

The aluminum fluoride (AlF₃) before being modified and the alkali metal or the alkali earth metal may be brought into contact in order to obtain the modified aluminum fluoride material serving as the negative electrode active material before being mixed with the other components of the negative electrode material mixture composite for a fluoride ion secondary battery according to the present invention or under presence of the other components.

### [Complexing Step]

The complexing step is a step of subjecting the negative electrode material mixture obtained in the mixture step to grinding and mixing treatment to complex the negative electrode active material, the fluoride ion conductive fluoride and the carbon black so as to obtain the composite.

In the complexing step, the negative electrode active material, the fluoride ion conductive fluoride and the carbon black included in the negative electrode material mixture are alloyed.

Since aluminum serving as the negative electrode active material is a relatively soft material, aluminum is carried by the fluoride ion conductive fluoride which is a hard material due to an impact caused by the grinding and mixing treatment. Then, it is considered that since aluminum is nanoparticles, aluminum can be thermally diffused within the composite due to heat caused by the grinding and mixing treatment, and that consequently, the composite is alloyed.

The grinding and mixing treatment for alloying and granulating the negative electrode material mixture is not particularly limited as long as the grinding and mixing treatment is a method in which the negative electrode material mixture can be mixed while being ground under an inert atmosphere.

Although the grinding and mixing treatment may be dry grinding or wet grinding, since an oxide film on the surface of the particles peels off at the time of the grinding and mixing treatment to cause an active surface to appear, the dry grinding under an inert atmosphere is preferable.

In the present invention, in particular, the grinding and mixing treatment is preferably performed with a ball mill. Since the ball mill is sealed, the mixing ratio is not changed during grinding and dispersion, the stable grinding and mixing treatment can be performed. Among types of ball mills, a planetary ball mill is preferable because large grinding power is produced to be able to perform fine grinding and reduce the grinding time. Although the conditions of the grinding and mixing when the ball mill is used are not particularly limited, for example, the grinding and mixing is performed at 400 rpm for 10 hours.

### EXAMPLES

Although Example and the like in the present invention will then be described, the present invention is not limited to Example and the like described below.

### Example 1

In Example 1, a modified aluminum fluoride material was used which was obtained by using aluminum and lithium (Li) metal as a negative electrode active material to modify aluminum fluoride (AlF₃). Then, CeBaF_{2.95} serving as a fluoride ion conductive fluoride and acetylene black serving as a conductive aid were used to produce a negative electrode material mixture composite for a fluoride ion secondary battery.

In Example 1, a first composite obtained by a first mixture step and a first complexing step and a second composite obtained by a second mixture step and a second complexing step were mixed in a third mixture step, and a third complexing step was performed and then the negative electrode material mixture composite for a fluoride ion secondary battery in Example 1 was finally obtained. In Example 1, the modified aluminum fluoride material was manufactured in the second mixture step.

### [First Mixture Step]

Aluminum, Ce_{0.95}Ba_{0.05}F_{2.95} and the acetylene black were weighed as shown in table 1. After the weighing, C and the acetylene black were put into a ball mill container made of silicon nitride (made by Fritsch Co., Ltd. in Germany, internal volume: 80 cc, PL-7 dedicated container), and then aluminum was put thereinto. Furthermore, 40 g of balls having a diameter of 2 mm and made of silicon nitride was put thereinto, and the ball mill container was sealed.

### [First Complexing Step]

The sealed ball mill container was rotated at a rotation speed of 400 rpm for 10 hours to perform grinding and mixing treatment, and thus the first composite was obtained. After the grinding and mixing treatment, the processed powder was collected.

### [Second Mixture Step: Manufacturing of Modified Aluminum Fluoride Material]

The aluminum fluoride (AlF₃), the lithium (Li) metal, Ce_{0.95}Ba_{0.05}F_{2.95} and the acetylene black were weighed as shown in table 1. After the weighing, the aluminum fluoride (AlF₃) and the lithium (Li) metal were put into a ball mill container made of silicon nitride (made by Fritsch Co., Ltd. in Germany, internal volume: 45 cc, PL-7 dedicated container), 40 g of balls having a diameter of 2 mm and made of silicon nitride was further put thereinto and the ball mill container was sealed. Then, the ball mill container was rotated at a rotation speed of 600 rpm for 30 hours to perform grinding and mixing treatment. After the grinding and mixing treatment, Ce_{0.95}Ba_{0.05}F_{2.95} and the acetylene black were put into the ball mill container, and the ball mill container was sealed.

Since each of the aluminum fluoride (AlF₃) and the lithium (Li) metal was highly reactive with water, the weighing and the preliminary mixing of the raw materials were performed within a glove box (made by Miwa Manufacturing Co., Ltd., model DBO-1.5BNK-SQ1).

### [Second Complexing Step]

The sealed ball mill container was rotated at a rotation speed of 200 rpm for 10 hours to perform grinding and mixing treatment, and thus the second composite was obtained. After the grinding and mixing treatment, the processed powder was collected.

### [Third Mixture Step]

The first composite obtained as described above was put into the ball mill container where the second composite obtained as described above and 40 g of balls having a diameter of 2 mm and made of silicon nitride were present, and the container was sealed.

### [Third Complexing Step]

The sealed ball mill container was rotated at a rotation speed of 200 rpm for 10 hours to perform grinding and mixing treatment, and thus the negative electrode material mixture composite for a fluoride ion secondary battery according to the present invention was finally obtained. After the grinding and mixing treatment, the processed powder was collected.

TABLE 1

| | | | Example 1 | Comparative Example 1 | Comparative Example 2 | |
|---|---|---|---|---|---|---|
| First | Negative electrode | Type | Aluminum | Modified aluminum | Aluminum | Silver |
| Composite | active material | | | fluoride | | [symbol] |
| | | | | | | [symbol] |
| | | Average particle | 40 | 49 | 40 | 100,000 |

| diameter [symbol] | | | | |
|---|---|---|---|---|
| Mixed amount [symbol] | 200 | 250 | 200 | 25 |

| | Fluoride ion | Type | [symbol] | | [symbol] | [symbol] |
|---|---|---|---|---|---|---|
| | conductive fluoride | Average particle | 10 | | 10 | 10 |
| | | diameter [symbol] | | | | |
| | | Mixed amount [symbol] | 1680 | | 1633 | 1633 |
| | Conductive aid | Type | Acetylene black | | Acetylene black | Acetylene black |
| | | Average particle | 35 | | 35 | 35 |
| | | diameter [symbol] | | | | |
| | | Mixed amount [symbol] | 120 | | 117 | 117 |
| Second | Negative electrode | Type | Aluminum | Lithium | — | — |
| Composite | | | fluoride | metal | | |
| | active Material | Average particle | 49 | (Foil) | — | — |
| | | diameter [symbol] | | | | |
| | | Mixed amount [symbol] | 225 | 25 | — | — |

| Fluoride ion | Type | [symbol] | — | — |
|---|---|---|---|---|
| conductive fluoride | Average particle | 10 | — | — |
| | diameter [symbol] | | | |
| | Mixed amount [symbol] | 1633 | — | — |
| Conductive aid | Type | Acetylene black | — | — |

| Average particle | 35 | — | — |
|---|---|---|---|
| diameter [symbol] | | | |
| Mixed amount [symbol] | 117 | — | — |

[symbol]

indicates data missing or illegible when filed

### Comparative Example 1

Modified aluminum fluoride disclosed in Japanese Unexamined Patent Application, Publication No. 2018-059703 was used as a negative electrode active material, Ce_{0.95}Ba_{0.05}F_{2.95} was used as a fluoride ion conductive fluoride and acetylene black was used as a conductive aid to produce a negative electrode material mixture for a fluoride ion secondary battery.

An operation for obtaining the modified aluminum fluoride is described below.

### [Modified Aluminum Fluoride]

Lithium (Li) metal was used, and thus aluminum fluoride (AlF₃) was formed into the modified aluminum fluoride.

### (Weighing and Preliminary Mixing of Raw Materials)

The aluminum fluoride (AlF₃) and the lithium (Li) metal were weighed such that aluminum fluoride:lithium (mole rate) was 90:10 and that the total amount was 6.0 grams. A mortar and a pestle made of agate were used to perform preliminary mixing for about 1 hour, and thus the mixed powder of raw materials was obtained.

Since each of the aluminum fluoride (AlF₃) and the lithium (Li) metal was highly reactive with water, the weighing and the preliminary mixing of the raw materials were performed within the glove box (made by Miwa Manufacturing Co., Ltd., model DBO-1.5BNK-SQ1).

### [Mixture Step]

The modified aluminum fluoride obtained as described above, Ce_{0.95}Ba_{0.05}F_{2.95} and the acetylene black were weighed as shown in table 1. After the weighing, aluminum was put into the ball mill container made of silicon nitride (made by Fritsch Co., Ltd. in Germany, internal volume: 80 cc, PL-7 dedicated container), and then Ce_{0.95}Ba_{0.05}F_{2.95} and the acetylene black were put thereinto. Furthermore, 40 g of balls having a diameter of 2 mm and made of silicon nitride was put thereinto, and the ball mill container was sealed.

### [Complexing Step]

The sealed ball mill container was rotated at a rotation speed of 600 rpm for 15 hours to perform grinding and mixing treatment, and thus a negative electrode material mixture composite for a fluoride ion secondary battery was obtained. After the grinding and mixing treatment, the processed powder was collected.

### Comparative Example 2

Aluminum and silver fluoride (AgF₂) serving as a negative electrode active material, CeBaF_{2.95} serving as a fluoride ion conductive fluoride and acetylene black serving as a conductive aid were used to produce a negative electrode material mixture composite for a fluoride ion secondary battery.

### [Mixture Step]

Aluminum, the silver fluoride (AgF₂), Ce_{0.95}Ba_{0.05}F_{2.95} and the acetylene black were weighed as shown in table 1. After the weighing, Ce_{0.95}Ba_{0.05}F_{2.95} and the acetylene black were put into the ball mill container made of silicon nitride (made by Fritsch Co., Ltd. in Germany, internal volume: 80 cc, PL-7 dedicated container), and then aluminum and the silver fluoride (AgF₂) were put thereinto. Furthermore, 40 g of balls having a diameter of 2 mm and made of silicon nitride was put thereinto, and the ball mill container was sealed.

### [Complexing Step]

The sealed ball mill container was rotated at a rotation speed of 400 rpm for 10 hours to perform grinding and mixing treatment, and thus the negative electrode material mixture composite for a fluoride ion secondary battery was obtained. After the grinding and mixing treatment, the processed powder was collected.

### <Production of Fluoride Ion Secondary Battery>

A fluoride ion secondary battery was produced using materials below by the following method.

### [Negative Electrode Material Mixture Powder]

The negative electrode material mixture composite for a fluoride ion secondary battery produced in Example and Comparative Examples was used.

### [Solid Electrolyte]

La_{0.95}Ba_{0.95}F_{2.95} (LBF) which was a tysonite-based solid electrolyte was used. The LBF was a known compound (see Non-Patent Documents 5 to 7), and thus the LBF was produced by a method disclosed in Non-Patent Document 5.
Non-Patent Document 5: ACS Appl. Mater. Interfaces 2014, 6, 2103-2110
Non-Patent Document 6: J. Phys. Chem. C 2013,117, 4943-4950
Non-Patent Document 7: J. Phys. Chem. C 2014,118, 7117-7129

### [Positive Electrode Material Mixture Powder]

63.7% by mass of lead fluoride powder (made by Kojundo Chemical Lab. Co., Ltd.), 29.6% by mass of tin fluoride (made by Kojundo Chemical Lab. Co., Ltd.) and 6.7% by mass of acetylene black (made by Denka Company Limited) were mixed with a ball mill, and were thereafter burned at 400° C. for 1 hour under an argon atmosphere to form into positive electrode material mixture powder.

### [Method for Producing Fluoride Ion Secondary Battery]

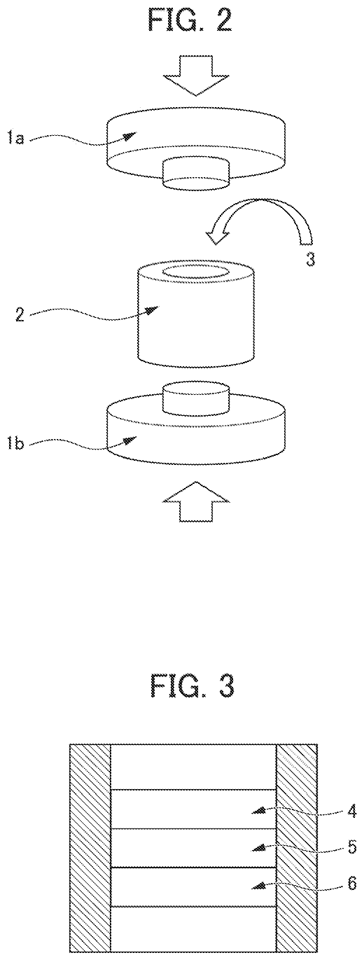

FIG. 2 shows a method for producing the fluoride ion secondary battery. As shown in FIG. 2, a tablet molder (1a and 1b) was used, battery materials 3 were sequentially put into a ceramic pipe 2 to be pressed at a pressure of 40 MPa from above and below and thus a pellet-type cell obtained by powder pressure molding was produced. As the battery materials 3, gold foil (made by the Nilaco Corporation, 99.9+%, thickness: 10 μm) serving as a negative electrode current collector, 10 mg of the negative electrode material mixture powder described above, 200 mg of the solid electrolyte, 30 mg of the positive electrode material mixture powder and lead foil (made by the Nilaco Corporation, purity: 99.99%, thickness: 200 μm) serving as a positive electrode current collector were sequentially put.

FIG. 3 shows a cross-sectional view of the fluoride ion secondary battery which was produced. As shown in FIG. 3, in a state where the pellet-type fluoride ion secondary battery produced was sandwiched by the tablet molder, a positive electrode material mixture layer 4, a solid electrolyte layer 5 and a negative electrode material mixture layer 6 were stacked.

### <Evaluations of Fluoride Ion Secondary Battery>

### [Constant Current Charge/Discharge Test]

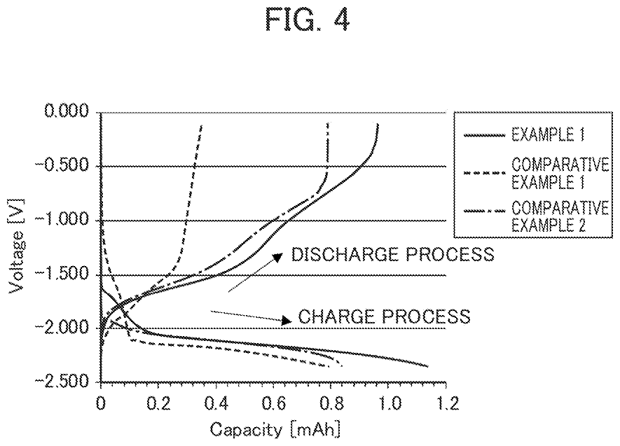

The pellet-type fluoride ion secondary battery obtained as described above was heated to 140° C. under a vacuum environment, and thus an electrochemical reaction (charge/discharge reactions) was performed. Specifically, a potentiometer galvanostat device (made by Solartron, SI1287/1255B) was used to perform a constant current charge/discharge test with a current of 0.02 mA for charge and a current of 0.01 mA for discharge at a lower limit voltage of −2.35 V and an upper limit voltage of −0.1 V by application of the current from a charge current. Charge/discharge curves are shown in FIGS. 4 to 6.

It is found from FIG. 4 that in the fluoride ion secondary battery using the negative electrode material mixture composite for a fluoride ion secondary battery according to the present invention, even when charge and discharge is performed by starting from charge, a difference between the capacity at the time of charge and the capacity at the time of discharge is low and the reversibility of the electrochemical reaction is improved. It is found that the discharge capacity is further improved and that the first composite enhances an electrochemical activity in the charge process of the second composite.

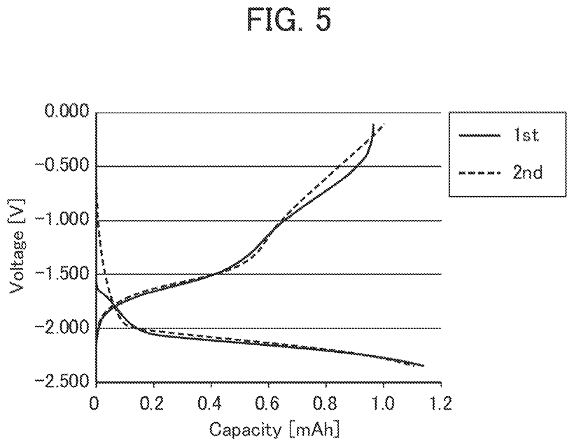

FIG. 5 is a graph showing a charge/discharge behavior in the first cycle and a charge/discharge behavior in the second cycle of the fluoride ion secondary battery produced in Example 1. It is found from FIG. 5 that the fluoride ion secondary battery using the negative electrode material mixture composite for a fluoride ion secondary battery according to the present invention also shows high coulomb efficiency in the second cycle.

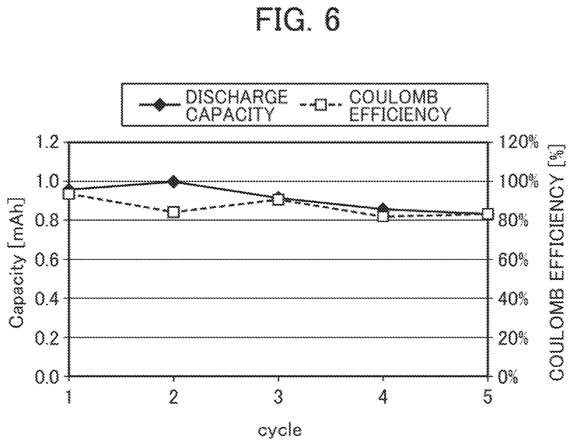

FIG. 6 is a graph showing the transition of the capacity up to the fifth cycle in the fluoride ion secondary battery produced in Example 1. It is found from FIG. 6 that the fluoride ion secondary battery using the negative electrode material mixture composite for a fluoride ion secondary battery according to the present invention also shows high coulomb efficiency in the second and subsequent cycles.

### EXPLANATION OF REFERENCE NUMERALS

1a, 1b: tablet molder
2: ceramic pipe
3: battery material
4: positive electrode material mixture layer
5: solid electrolyte layer
6: negative electrode material mixture layer

1. A negative electrode material mixture composite for a fluoride ion secondary battery comprising: a negative electrode active material; and a fluoride ion conductive fluoride,
wherein the negative electrode active material comprises aluminum and a modified aluminum fluoride material having pores caused by desorption of fluoride ions.

2. The negative electrode material mixture composite for a fluoride ion secondary battery according to claim 1, wherein the pores serve as a starting point of a defluorination reaction and a refluorination reaction.

3. The negative electrode material mixture composite for a fluoride ion secondary battery according to claim 1, wherein the pores are a region where fluorine atoms were present in the aluminum fluoride before being modified.

4. The negative electrode material mixture composite for a fluoride ion secondary battery according to claim 1, wherein the aluminum is in the form of particles with an average particle diameter of 10 nm to 200 nm.

5. The negative electrode material mixture composite for a fluoride ion secondary battery according to claim 1, further comprising carbon black.

6. A negative electrode for a fluoride ion secondary battery comprising the negative electrode material mixture composite for a fluoride ion secondary battery according to claim 1.

7. A fluoride ion secondary battery comprising: the negative electrode according to claim 6; a solid electrolyte; and a positive electrode.

8. A method for manufacturing a negative electrode material mixture composite for a fluoride ion secondary battery, the method comprising:
a mixture step of mixing a negative electrode active material, a fluoride ion conductive fluoride and carbon black to obtain a negative electrode material mixture; and
a complexing step of subjecting the negative electrode material mixture to grinding and mixing treatment to complex the negative electrode active material, the fluoride ion conductive fluoride and the carbon black so as to obtain a composite,
wherein the negative electrode active material comprises aluminum and a modified aluminum fluoride material having pores caused by desorption of fluoride ions.

9. The method for manufacturing a negative electrode material mixture composite for a fluoride ion secondary battery according to claim 8, wherein the pores serve as a starting point of a defluorination reaction and a refluorination reaction.

10. The method for manufacturing a negative electrode material mixture composite for a fluoride ion secondary battery according to claim 8, wherein the pores are a region where fluorine atoms were present in the aluminum fluoride before being modified.

11. The method for manufacturing a negative electrode material mixture composite for a fluoride ion secondary battery according to claim 8, wherein the aluminum is I the form of particles with an average particle diameter of 10 nm to 200 nm.

12. The method for manufacturing a negative electrode material mixture composite for a fluoride ion secondary battery according to claim 8, wherein the grinding and mixing treatment is dry grinding.

13. The method for manufacturing a negative electrode material mixture composite for a fluoride ion secondary battery according to claim 8, wherein the grinding and mixing treatment is performed with a ball mill.
